(19) United States
(12) Patent Application Publication
(10) Pub. No.: US 2026/0080820 A1
(43) Pub. Date: Mar. 19, 2026

(54) PIXEL CIRCUIT AND DRIVING METHOD THEREFOR

(71) Applicant: Yungu (Gu’an) Technology Co., Ltd., Langfang (CN)

(72) Inventors: Enqing GUO, Langfang (CN); Cuili GAI, Langfang (CN); Junfeng LI, Langfang (CN); Kangguan PAN, Langfang (CN)

(73) Assignee: Yungu (Gu’an) Technology Co., Ltd., Langfang (CN)

(21) Appl. No.: 19/402,872

(22) Filed: Nov. 26, 2025

Related U.S. Application Data
(63) Continuation of application No. PCT/CN2024/091841, filed on May 9, 2024.

(30) Foreign Application Priority Data
May 31, 2023 (CN) 202310637058.6
Sep. 22, 2023 (CN) 202311236951.4

(51) Int. Cl. G09G 3/32

(52) U.S. Cl. CPC G09G 3/32; G09G 2300/043; G09G 2300/0819; G09G 2300/0842; G09G 2310/08; G09G 2320/0233; G09G 2320/0247; G09G 2330/021

(57) ABSTRACT

Disclosed are a pixel circuit and a driving method therefor. The pixel circuit includes: a driving module (110), a voltage writing module (120), a compensation module (130), a coupling module (140), and a first initialization module (150). The first initialization module (150) is connected to a second terminal N2 of the driving module (110). The first initialization module (150) is configured to control a magnitude of a current flowing through the driving module (110). The compensation module (130) is connected between a control terminal G and a first terminal N1 of the driving module (110). The compensation module (130) is configured to compensate for a threshold voltage of the driving module (110) in a compensation phase based on a voltage at the first terminal N1 of the driving module (110) obtained after the first terminal N1 is discharged via the driving module (110) and the first initialization module (150).

### CROSS-REFERENCE TO RELATED APPLICATIONS

The present application is a continuation of International Application No. PCT/CN2024/091841 filed on May 9, 2024, which claims priorities to Chinese Patent Application No. 202310637058.6, filed with the China National Intellectual Property Administration on May 31, 2023, and to Chinese Patent Application No. 202311236951.4, filed with the China National Intellectual Property Administration on Sep. 22, 2023, all of which are incorporated herein by reference in their entireties.

### FIELD

The present application relates to the field of display technologies, for example, to a pixel circuit and a driving method therefor.

### BACKGROUND

With the continuous development of display technologies, people have increasingly high requirements for display quality.

A display panel usually includes pixel circuits, where the pixel circuit includes a drive transistor that generates a drive signal to drive a light-emitting element to emit light for display. However, during a non-light-emitting process of the pixel circuit, a current flowing through the drive transistor is large, resulting in increased power consumption.

### SUMMARY

Embodiments of the present application provide a pixel circuit and a driving method therefor, to reduce power consumption of the pixel circuit.

According to one embodiment of the present application, a pixel circuit is provided, including: a driving module, a voltage writing module, a compensation module, a coupling module, and a first initialization module.

The first initialization module is connected to a second terminal of the driving module, and the first initialization module is configured to control a magnitude of a current flowing through the driving module.

The compensation module is connected between a control terminal and a first terminal of the driving module, and the compensation module is configured to compensate for a threshold voltage of the driving module in a compensation phase based on a voltage at the first terminal of the driving module obtained after the first terminal is discharged via the driving module and the first initialization module.

A first terminal of the coupling module is connected to the voltage writing module, a second terminal of the coupling module is connected to the first terminal of the driving module, the voltage writing module is configured to output a fixed voltage to the first terminal of the coupling module at least in the compensation phase and output a data voltage to the first terminal of the coupling module in a data writing phase, and the coupling module is configured to couple a voltage containing information about the data voltage to the control terminal of the driving module via the compensation module in the data writing phase, where the data writing phase is later than the compensation phase.

In one embodiment, the pixel circuit further includes a light-emitting module. The driving module and the light-emitting module are connected between a first power supply voltage terminal and a second power supply voltage terminal, and the driving module is configured to drive the light-emitting module to emit light in a light emission phase.

In one embodiment, the pixel circuit further includes a first light emission control module and a second light emission control module. The second light emission control module is connected between the first power supply voltage terminal and the first terminal of the driving module, the first light emission control module is connected between the second terminal of the driving module and a first terminal of the light-emitting module, and a second terminal of the light-emitting module is connected to the second power supply voltage terminal. A control terminal of the first light emission control module and a control terminal of the second light emission control module are both connected to a light emission control signal line.

In one embodiment, the pixel circuit further includes a second initialization module. The second initialization module is connected between a second initialization signal line and the first terminal of the light-emitting module, a control terminal of the second initialization module is connected to a first scan line, and the second initialization module is configured to transmit a second initialization voltage on the second initialization signal line to the first terminal of the light-emitting module at least in the compensation phase.

In one embodiment, the first initialization module is connected between a first initialization signal line and the second terminal of the driving module. A first initialization voltage on the first initialization signal line is greater than the second initialization voltage.

In one embodiment, a control terminal of the compensation module is connected to a second scan line.

In one embodiment, a start moment of the data writing phase is later than an end moment of the compensation phase.

In one embodiment, the voltage writing module includes a data writing unit. A control terminal of the data writing unit is connected to a third scan line, a first terminal of the data writing unit is connected to a data line, and a second terminal of the data writing unit is connected to the first terminal of the coupling module.

The data line is configured to transmit the fixed voltage in an initialization phase to initialize a potential at the first terminal of the coupling module, continue transmitting the fixed voltage in the compensation phase, and transmit the data voltage in the data writing phase.

In one embodiment, the compensation module is further configured to transmit a potential at the first terminal of the driving module to the control terminal of the driving module in the compensation phase.

In one embodiment, the voltage writing module includes a data writing unit and a reset unit. A first terminal of the reset unit is connected to the fixed voltage, a second terminal of the reset unit is connected to the first terminal of the coupling module, the first terminal of the coupling module is further connected to a second terminal of the data writing unit, a first terminal of the data writing unit is connected to a data line, a control terminal of the data writing unit is connected to a third scan line, a control terminal of the reset unit is connected to a fourth scan line, the reset unit is configured to transmit the fixed voltage to the first terminal of the coupling module in an initialization phase and continue transmitting the fixed voltage to the first terminal of the coupling module in the compensation phase, and the data writing unit is configured to transmit the data voltage to the first terminal of the coupling module in the data writing phase.

In one embodiment, the data line is configured to transmit the data voltage at least in the data writing phase.

In one embodiment, the first initialization module is connected between a first initialization signal line and the second terminal of the driving module, a first initialization voltage on the first initialization signal line is reused as the fixed voltage, and a control terminal of the first initialization module is connected to the fourth scan line.

In one embodiment, the pixel circuit further includes a storage module. The storage module is connected between the control terminal of the driving module and a first terminal of a light-emitting module.

In one embodiment, the first scan line is reused as the second scan line.

The pixel circuit further includes a third initialization module. A control terminal of the third initialization module is connected to a fifth scan line, a first terminal of the third initialization module is connected to the second initialization signal line, a second terminal of the third initialization module is connected to the first terminal of the light-emitting module, and the third initialization module is configured to transmit the second initialization voltage to the first terminal of the light-emitting module in an initialization phase in a write frame of a display cycle, and transmit the second initialization voltage to the first terminal of the light-emitting module in an initialization phase in a hold frame of the same display cycle.

According to another embodiment of the present application, a pixel circuit is provided, including: a driving module, a compensation module, a first initialization module, a second initialization module, a first light emission control module, and a light-emitting module.

The driving module and the light-emitting module are connected between a first power supply voltage terminal and a second power supply voltage terminal, and the driving module is configured to drive the light-emitting module to emit light in a light emission phase.

The first light emission control module is connected between a second terminal of the driving module and a first terminal of the light-emitting module, the first initialization module is connected to the second terminal of the driving module, and the first initialization module is configured to control a magnitude of a current flowing through the driving module based on a first initialization voltage connected to the first initialization module.

The second initialization module is connected to the first terminal of the light-emitting module, and the second initialization module is configured to transmit a second initialization voltage to the first terminal of the light-emitting module at least in a compensation phase, where the first initialization voltage is greater than the second initialization voltage.

The compensation module is connected between a control terminal and a first terminal of the driving module, and the compensation module is configured to compensate for a threshold voltage of the driving module in the compensation phase based on a voltage at the first terminal of the driving module obtained after the first terminal is discharged via the driving module and the first initialization module.

In one embodiment, the pixel circuit further includes a voltage writing module and a coupling module. The voltage writing module is configured to output a fixed voltage to a first terminal of the coupling module at least in the compensation phase and output a data voltage to the first terminal of the coupling module in a data writing phase, and the coupling module is configured to couple a voltage containing information about the data voltage to the control terminal of the driving module via the compensation module in the data writing phase, where the data writing phase is later than the compensation phase.

In one embodiment, a start moment of the data writing phase is later than an end moment of the compensation phase.

In one embodiment, the voltage writing module includes a data writing unit. A control terminal of the data writing unit is connected to a third scan line, a first terminal of the data writing unit is connected to a data line, and a second terminal of the data writing unit is connected to the first terminal of the coupling module. The data line is configured to transmit the fixed voltage in an initialization phase to initialize a potential at the first terminal of the coupling module, continue transmitting the fixed voltage in the compensation phase, and transmit the data voltage in the data writing phase.

In one embodiment, the voltage writing module includes a data writing unit and a reset unit. A first terminal of the reset unit is connected to the fixed voltage, a second terminal of the reset unit is connected to the first terminal of the coupling module, a second terminal of the coupling module is connected to the first terminal of the driving module, the first terminal of the coupling module is further connected to a second terminal of the data writing unit, a first terminal of the data writing unit is connected to a data line, a control terminal of the data writing unit is connected to a third scan line, a control terminal of the reset unit is connected to a fourth scan line, the reset unit is configured to transmit the fixed voltage to the first terminal of the coupling module in an initialization phase and continue transmitting the fixed voltage to the first terminal of the coupling module in the compensation phase, and the data writing unit is configured to transmit the data voltage to the first terminal of the coupling module in the data writing phase.

In one embodiment, the pixel circuit further includes a second light emission control module. The second light emission control module is connected between the first power supply voltage terminal and the first terminal of the driving module, and a control terminal of the first light emission control module and a control terminal of the second light emission control module are both connected to a light emission control signal line.

In one embodiment, the pixel circuit further includes a storage module. The storage module is connected between the control terminal of the driving module and the first terminal of the light-emitting module.

According to another embodiment of the present application, a driving method for a pixel circuit is provided. The pixel circuit includes a driving module, a voltage writing module, a compensation module, a coupling module, and a first initialization module. The driving method for a pixel circuit includes:
in an initialization phase, controlling the voltage writing module to output a fixed voltage to a first terminal of the coupling module;
in a compensation phase, controlling the compensation module to compensate for a threshold voltage of the driving module based on a voltage at a first terminal of the driving module obtained after the first terminal is discharged via the driving module and the first initialization module, controlling a magnitude of a current flowing through the driving module via a first initialization voltage, and controlling the voltage writing module to continue outputting the fixed voltage to the first terminal of the coupling module; and
in a data writing phase, controlling the voltage writing module to output a data voltage to the first terminal of the coupling module, and controlling the coupling module to couple a voltage containing information about the data voltage to a control terminal of the driving module via the compensation module.

In one embodiment, the pixel circuit further includes a second initialization module, and at least in the compensation phase, the second initialization module is controlled to transmit a second initialization voltage to a first terminal of a light-emitting module.

In one embodiment, the first initialization voltage is greater than the second initialization voltage.

In one embodiment, the voltage writing module includes a data writing unit and a reset unit.

The controlling the voltage writing module to output a fixed voltage to a first terminal of the coupling module includes:
controlling the reset unit to transmit the fixed voltage to the first terminal of the coupling module.

The controlling the voltage writing module to output a data voltage to the first terminal of the coupling module includes:
controlling the data writing unit to output the data voltage to the first terminal of the coupling module.

In one embodiment, in the initialization phase, the driving method for a pixel circuit further includes: controlling a first power supply voltage to be transmitted to the first terminal of the driving module.

According to another embodiment of the present application, a driving method for a pixel circuit is provided. The pixel circuit includes a driving module, a compensation module, a first initialization module, a second initialization module, and a light-emitting module.

The driving method for a pixel circuit includes:
in a compensation phase, controlling the compensation module to compensate for a threshold voltage of the driving module based on a voltage at a first terminal of the driving module obtained after the first terminal is discharged via the driving module and the first initialization module, controlling a magnitude of a current flowing through the driving module via a first initialization voltage connected to the first initialization module, and controlling the second initialization module to transmit a second initialization voltage to a first terminal of the light-emitting module, where the first initialization voltage is greater than the second initialization voltage.

According to the embodiments of the present application, the compensation module is provided between the control terminal and the first terminal of the driving module. In the compensation phase, the compensation module is controlled to be turned on, the potential at the first terminal of the driving module is transmitted to the control terminal of the driving module, and the driving module is turned on, and the compensation module compensates for the threshold voltage of the driving module based on the voltage at the first terminal of the driving module obtained after the first terminal is discharged via the driving module and the first initialization module. A magnitude of the first initialization voltage is adjusted, and the current flowing through the driving module can be adjusted. This effectively avoids a problem of increased power consumption caused by an excessively large current, and can reduce a problem of display nonuniformity caused by a voltage drop (IR-Drop) of the first initialization voltage, thereby helping improve a display effect. Furthermore, in this embodiment, threshold compensation and data writing for the driving module are not performed simultaneously, and the threshold compensation is performed before the data voltage is written to the control terminal of the driving module. Therefore, the threshold compensation phase and the data writing phase do not affect each other, time for the threshold compensation is not affected by line time, and the threshold voltage of the driving module can be fully compensated even at a high refresh rate. This can reduce a difference in characteristics of driving modules corresponding to different pixels, and then helps reduce a difference in display brightness, thereby improving uniformity of a displayed image.

### BRIEF DESCRIPTION OF THE DRAWINGS

FIG. 1 is a schematic diagram of a structure of a pixel circuit according to an embodiment of the present application;

FIG. 2 is a schematic diagram of a structure of another pixel circuit according to an embodiment of the present application;

FIG. 3 is a schematic diagram of a structure of another pixel circuit according to an embodiment of the present application;

FIG. 4 is a schematic diagram of a structure of another pixel circuit according to an embodiment of the present application;

FIG. 5 is a schematic diagram of a structure of another pixel circuit according to an embodiment of the present application;

FIG. 6 is a schematic diagram of a structure of another pixel circuit according to an embodiment of the present application;

FIG. 7 is a schematic diagram of driving timing of a pixel circuit according to an embodiment of the present application;

FIG. 8 is a schematic diagram of driving timing of another pixel circuit according to an embodiment of the present application;

FIG. 9 is a schematic diagram of driving timing of another pixel circuit according to an embodiment of the present application;

FIG. 10 is a schematic diagram of a simulation of a compensation effect according to an embodiment of the present application;

FIG. 11 is a schematic diagram of gray scale expansion according to an embodiment of the present application;

FIG. 12 is a schematic diagram of a simulation of IR-Drop in a second power supply voltage according to an embodiment of the present application;

FIG. 13 is a schematic diagram of a structure of another pixel circuit according to an embodiment of the present application;

FIG. 14 is a schematic diagram of a structure of another pixel circuit according to an embodiment of the present application;

FIG. 15 is a schematic diagram of driving timing of another pixel circuit according to an embodiment of the present application;

FIG. 16 is a schematic diagram of a structure of another pixel circuit according to an embodiment of the present application;

FIG. 17 is a flowchart of a driving method for a pixel circuit according to an embodiment of the present application;

FIG. 18 is a flowchart of another driving method for a pixel circuit according to an embodiment of the present application;

FIG. 19 is a flowchart of another driving method for a pixel circuit according to an embodiment of the present application; and

FIG. 20 is a schematic diagram of a structure of a display panel according to an embodiment of the present application.

### DETAILED DESCRIPTION OF THE EMBODIMENTS

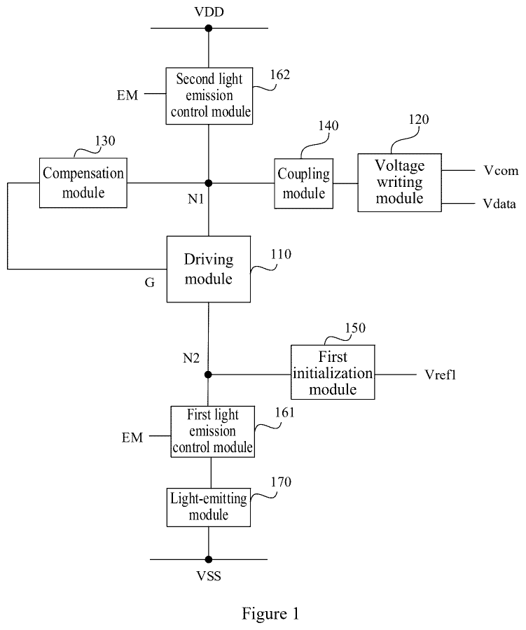

FIG. 1 is a schematic diagram of a structure of a pixel circuit according to an embodiment of the present application. Referring to FIG. 1, the pixel circuit according to an embodiment of the present application includes a driving module 110, a voltage writing module 120, a compensation module 130, a coupling module 140, and a first initialization module 150. The first initialization module 150 is connected to a second terminal N2 of the driving module 110, and the first initialization module 150 is configured to control a magnitude of a current flowing through the driving module 110. In this embodiment, the current flowing through the driving module 110 may be a reset current.

The compensation module 130 is connected between a control terminal G and a first terminal N1 of the driving module 110. The compensation module 130 is configured to compensate for a threshold voltage of the driving module 110 in a compensation phase based on a voltage at the first terminal N1 of the driving module 110 obtained after the first terminal N1 is discharged via the driving module 110 and the first initialization module 150.

A first terminal of the coupling module 140 is connected to the voltage writing module 120, and a second terminal of the coupling module 140 is connected to the first terminal N1 of the driving module 110. The voltage writing module 120 is configured to output a fixed voltage Vcom to the first terminal of the coupling module 140 at least in the compensation phase and output a data voltage Vdata to the first terminal of the coupling module 140 in a data writing phase. The coupling module 140 is configured to couple a voltage containing information about the data voltage Vdata to the control terminal G of the driving module 110 via the compensation module 130 in the data writing phase.

The first initialization module 150 may be connected to a first initialization signal line and control the magnitude of the current flowing through the driving module 110 based on a magnitude of a first initialization voltage Vref1 on the first initialization signal line.

The pixel circuit shown in FIG. 1 is used as an example. An operation process of the pixel circuit includes at least an initialization phase, a compensation phase, a data writing phase, and a light emission phase. The data writing phase is later than the compensation phase.

In the initialization phase, the voltage writing module 120 transmits the fixed voltage Vcom to the first terminal of the coupling module 140, and transmits a first power supply voltage VDD at a first power supply voltage terminal to the second terminal of the coupling module 140, to initialize the coupling module 140. At the same time, the first initialization module 150 is turned on, and transmits the first initialization voltage Vref1 to the second terminal N2 of the driving module 110, to initialize the second terminal N2 of the driving module 110.

In the compensation phase, the compensation module 130 is turned on, and transmits the first power supply voltage VDD at the first terminal N1 of the driving module 110 to the control terminal G. The first terminal N1 of the driving module 110 is discharged via the driving module 110, the first initialization module 150, and the first initialization signal line, and the driving module 110 is turned off until a voltage difference between the control terminal G and the second terminal N2 of the driving module 110 is equal to the threshold voltage of the driving module 110. A voltage at the control terminal G of the driving module 110 is a voltage associated with the threshold voltage of the driving module 110, implementing threshold compensation for the driving module 110.

In the initialization phase and the compensation phase, the magnitude of the first initialization voltage Vref1 is appropriately set, and the magnitude of the current flowing through the driving module 110 can be controlled, where the current is jointly determined by the driving module 110 and a difference between the first power supply voltage VDD and the first initialization voltage Vref1. The magnitude of the first initialization voltage Vref1 is adjusted and controlled, and an excessively large current flowing through the driving module 110 can be avoided. This helps reduce power consumption of the pixel circuit, and can reduce a problem of display nonuniformity caused by IR-Drop in the first initialization voltage Vref1, thereby helping improve a display effect.

In the data writing phase, the voltage writing module 120 transmits the data voltage Vdata to the first terminal of the coupling module 140, and a voltage at the first terminal of the coupling module 140 jumps from the fixed voltage Vcom to the data voltage Vdata. The coupling module couples a voltage associated with the data voltage Vdata to the control terminal G of the driving module 110 via the compensation module 130, and the voltage at the control terminal G of the driving module 110 is associated with the data voltage Vdata.

The driving module 110 and a light-emitting module 170 are connected between the first power supply voltage terminal and a second power supply voltage terminal, and the driving module 110 is configured to generate a drive current, to drive the light-emitting module 170 to emit light in the light emission phase.

According to the embodiments of the present application, the compensation module 130 is provided between the control terminal G and the first terminal N1 of the driving module 110. In the compensation phase, the compensation module 130 is controlled to be turned on, and a potential at the first terminal N1 of the driving module 110 is transmitted to the control terminal G of the driving module 110, and the driving module 110 is turned on; and the compensation module 130 compensates for the threshold voltage of the driving module 110 based on the voltage at the first terminal N1 of the driving module 110 obtained after the first terminal N1 is discharged via the driving module 110 and the first initialization module 150. The magnitude of the first initialization voltage is adjusted, and the current flowing through the driving module 110 can be adjusted. This effectively avoids a problem of increased power consumption caused by an excessively large current, and can reduce the problem of display nonuniformity caused by the IR-Drop in the first initialization voltage, thereby helping improve the display effect. Furthermore, in this embodiment, the threshold compensation and data writing for the driving module 110 are not performed simultaneously, and the threshold compensation is performed before the data voltage is written to the control terminal G of the driving module 110. Therefore, the threshold compensation phase and the data writing phase do not affect each other, time for the threshold compensation is not affected by line time, and the threshold voltage of the driving module 110 can be fully compensated even at a high refresh rate. This can reduce a difference in characteristics of driving modules 110 corresponding to different pixels, and then helps reduce a difference in display brightness, thereby improving uniformity of a displayed image.

In this embodiment, a start moment of the data writing phase is later than an end moment of the compensation phase, and the data writing phase and the compensation phase are completely separated. Therefore, the threshold compensation phase and the data writing phase do not affect each other, and the time for the threshold compensation is not limited by the line time.

Still referring to FIG. 1, the pixel circuit according to this embodiment further includes a first light emission control module 161 and a second light emission control module 162. The second light emission control module 162 is connected between the first power supply voltage terminal and the first terminal N1 of the driving module 110. The first light emission control module 161 is connected between the second terminal N2 of the driving module 110 and a first terminal of the light-emitting module 170. A second terminal of the light-emitting module 170 is connected to the second power supply voltage terminal. A control terminal of the first light emission control module 161 and a control terminal of the second light emission control module 162 are both connected to a light emission control signal line. The light emission control signal line is configured to transmit a light emission control signal EM.

In this embodiment, the first power supply voltage terminal is configured to be connected to the first power supply voltage VDD, and the second power supply voltage terminal is configured to be connected to a second power supply voltage VSS. The first power supply voltage VDD may be a positive voltage, and the second power supply voltage VSS may be a negative voltage.

The first light emission control module 161 and the second light emission control module 162 are configured to be turned on in the initialization phase, to transmit the first power supply voltage VDD to the first terminal N1 of the driving module 110. Because the first initialization voltage Vref1 is transmitted to the second terminal N2 of the driving module 110 via the first initialization module 150, the light-emitting module 170 does not emit light.

In this embodiment, the compensation module 130 is in an off state in the initialization phase. The driving module 110 includes a drive transistor. When the compensation module 130 is turned on, the drive transistor is in a diode-connected state. When the first power supply voltage VDD is transmitted to the first terminal N1 of the driving module 110, the drive transistor is conducted, which may result in a large current generated via the first initialization module 150 and the first initialization signal line. When the compensation module 130 is turned off, the drive transistor can be cut off, thereby helping reduce a current flowing through the drive transistor.

In another embodiment, the compensation module 130 may be in an on state in the initialization phase.

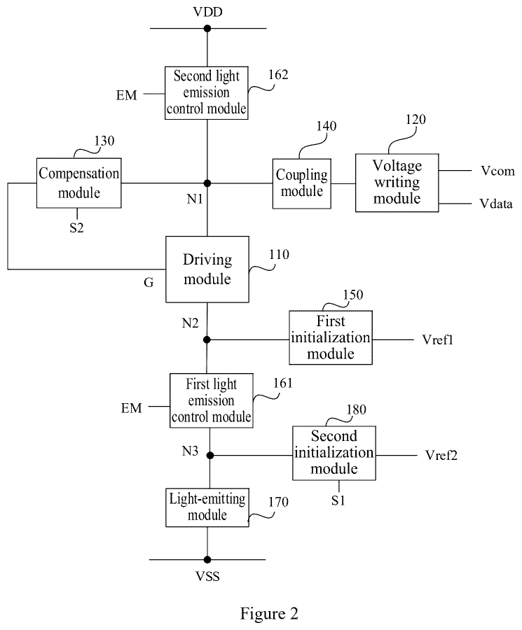

FIG. 2 is a schematic diagram of a structure of another pixel circuit according to an embodiment of the present application. Referring to FIG. 2, based on the above embodiments, the pixel circuit further includes a second initialization module 180. The second initialization module 180 is connected between a second initialization signal line and the first terminal of the light-emitting module 170. A control terminal of the second initialization module 180 is connected to a first scan line. The second initialization module 180 is configured to transmit a second initialization voltage Vref2 on the second initialization signal line to the first terminal of the light-emitting module 170 at least in the compensation phase.

For example, the second initialization module 180 and the first terminal of the light-emitting module 170 are connected to a third node N3. The second initialization module 180 is configured to be turned on at least in the compensation phase in response to a first scan signal S1 on the first scan line, to transmit the second initialization voltage Vref2 to the first terminal of the light-emitting module 170 to initialize the first terminal of the light-emitting module 170.

In this embodiment, the first initialization voltage Vref1 is greater than the second initialization voltage Vref2. The first initialization voltage Vref1 and the second initialization voltage Vref2 may be negative voltages, for example, Vref2=−5 V, and Vref1=−3 V. The purpose of setting like this is that the first terminal of the light-emitting module 170 can be reset to a lower voltage via the lower second initialization voltage Vref2, to ensure that the first terminal of the light-emitting module 170 is fully initialized, where the second initialization voltage Vref2 is lower than a turn-on voltage of the light-emitting module 170. In addition, setting the higher first initialization voltage Vref1 can reduce a voltage difference between the first power supply voltage VDD and the first initialization voltage Vref1, and can therefore control the current within a small range, to avoid an excessively large current flowing through the driving module 110, thereby helping reduce power consumption.

In part of other embodiments, the first initialization voltage Vref1 may be a positive voltage, and/or the second initialization voltage Vref2 may be a positive voltage.

In one embodiment, the second initialization module 180 may be turned on in the initialization phase or the data writing phase in response to the first scan signal S1.

In one embodiment, a control terminal of the compensation module 130 may be connected to a second scan line to respond to a second scan signal S2 on the second scan line. The compensation module 130 and the second initialization module 180 are connected to different scan lines, and at a low frequency, the first terminal of the light-emitting module 170 of the pixel circuit can be reset at a high frequency, thereby helping reduce flicker in a displayed image.

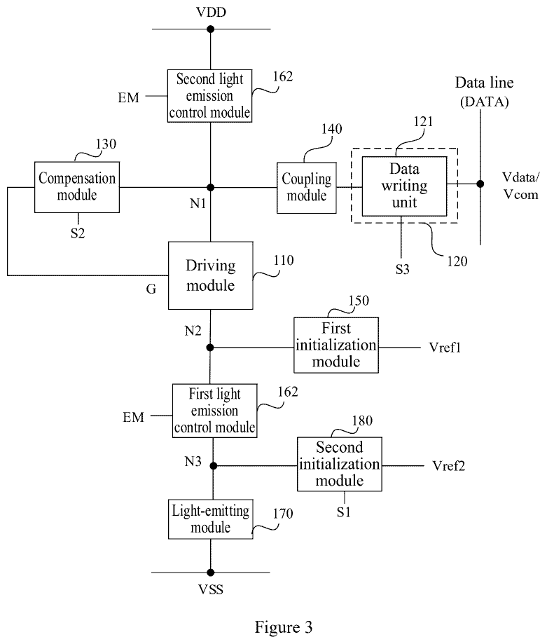

FIG. 3 is a schematic diagram of a structure of another pixel circuit according to an embodiment of the present application. Referring to FIG. 3, based on the embodiments described above, in one embodiment, the voltage writing module 120 includes a data writing unit 121. A control terminal of the data writing unit 121 is connected to a third scan line, a first terminal of the data writing unit 121 is connected to a data line DATA, and a second terminal of the data writing unit 121 is connected to the first terminal of the coupling module 140. The data line DATA is configured to transmit the fixed voltage Vcom in the initialization phase to initialize a potential at the first terminal of the coupling module 140, continue transmitting the fixed voltage Vcom in the compensation phase, and transmit the data voltage Vdata in the data writing phase.

For example, in the initialization phase, the data writing unit 121 is turned on in response to a third scan signal S3 transmitted on the third scan line, and outputs the fixed voltage Vcom transmitted on the data line DATA to the first terminal of the coupling module 140. At the same time, the first power supply voltage VDD is transmitted to the second terminal of the coupling module 140 (i.e., the first terminal N1 of the driving module 110) via the second light emission control module 162, to maintain voltages at the two terminals of the coupling module 140 stable.

In the compensation phase, the first terminal N1 and the control terminal G of the driving module 110 are short-circuited, and the compensation module 130 transmits a voltage at the first terminal N1 of the driving module 110 to the control terminal G. The first terminal N1 of the driving module 110 is discharged via the driving module 110 and the first initialization module 150, and the driving module 110 is turned off until the voltage difference between the control terminal G and the second terminal N2 of the driving module 110 is equal to the threshold voltage of the driving module 110. In this process, the data line DATA continues transmitting the fixed voltage Vcom to the first terminal of the coupling module 140.

In the data writing phase, the voltage transmitted on the data line DATA changes to the data voltage Vdata. The data writing unit 121 remains turned on in response to the third scan signal S3 transmitted on the third scan line, and outputs the data voltage Vdata transmitted on the data line DATA to the first terminal of the coupling module 140. The voltage at the first terminal of the coupling module 140 jumps. Under a coupling action of the coupling module 140, a difference between the data voltage Vdata and the fixed voltage Vcom is coupled to the first terminal N1 of the driving module 110 and transmitted to the control terminal G of the driving module 110 via the compensation module 130, to write the data voltage Vdata to the control terminal G of the driving module 110. The second initialization module 180 remains turned on in response to the first scan signal S1, to prevent the light-emitting module 170 from emitting light.

In this embodiment, the data line DATA is reused to transmit the fixed voltage Vcom and the data voltage Vdata in a time-division manner, and the data voltage Vdata can be written to the control terminal G of the driving module 110 in the data writing phase, thereby helping reduce the number of signal lines to achieve high PPI.

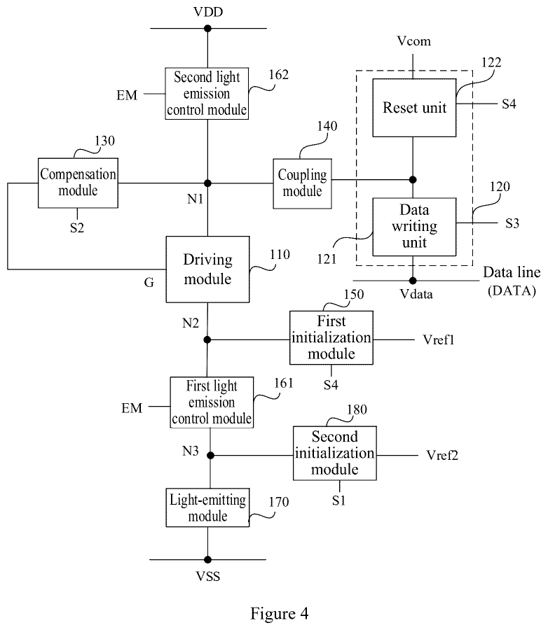

Another embodiment provided in the present application, the data voltage Vdata and the fixed voltage Vcom may be transmitted using different signal lines, to prevent interference between the data voltage Vdata and the fixed voltage Vcom. FIG. 4 is a schematic diagram of a structure of another pixel circuit according to an embodiment of the present application. Referring to FIG. 4, in one embodiment, the voltage writing module 120 includes a data writing unit 121 and a reset unit 122. A first terminal of the reset unit 122 is connected to the fixed voltage Vcom, and a second terminal of the reset unit 122 is connected to the first terminal of the coupling module 140. The second terminal of the coupling module 140 is connected to the first terminal N1 of the driving module 110. The first terminal of the coupling module 140 is further connected to a second terminal of the data writing unit 121. A first terminal of the data writing unit 121 is connected to a data line DATA. A control terminal of the data writing unit 121 is connected to a third scan line. A control terminal of the reset unit 122 is connected to a fourth scan line. The reset unit 122 is configured to transmit the fixed voltage Vcom to the first terminal of the coupling module 140 in the initialization phase and continue transmitting the fixed voltage Vcom to the first terminal of the coupling module 140 in the compensation phase. The data writing unit 121 is configured to transmit the data voltage Vdata to the first terminal of the coupling module 140 in the data writing phase.

The third scan line is configured to transmit the third scan signal S3, and the fourth scan line is configured to transmit a fourth scan signal S4. Here, the fixed voltage Vcom may be supplied by a power supply line, and the data line DATA is merely configured to transmit the data voltage Vdata.

In one embodiment, the first initialization module 150 and the reset unit 122 may be connected to the same scan line, for example, both connected to the fourth scan line, to reduce the number of scan lines. A control terminal of the first initialization module 150 is connected to the fourth scan line.

In one embodiment, the fixed voltage Vcom is the same as the first power supply voltage VDD. That is, the first terminal of the reset unit 122 is connected to the first power supply voltage terminal, and the first power supply voltage VDD is reused as the fixed voltage Vcom, which can reduce the number of power supply lines.

In one embodiment, the first initialization voltage Vref1 is the same as the fixed voltage Vcom. That is, the first terminal of the reset unit 122 is connected to the first initialization signal line, and the first initialization voltage Vref1 is reused as the fixed voltage Vcom, to reduce the number of power supply lines.

In one embodiment, in part of specific cases, the fixed voltage Vcom is a high voltage. In this case, the first initialization module 150 and the reset unit 122 may be configured to be connected to different scan lines. In the initialization phase, the fixed voltage Vcom is transmitted on the first initialization signal line. In the compensation phase, the voltage transmitted on the first initialization signal line jumps from the fixed voltage Vcom to the first initialization voltage Vref1, to ensure a compensation effect.

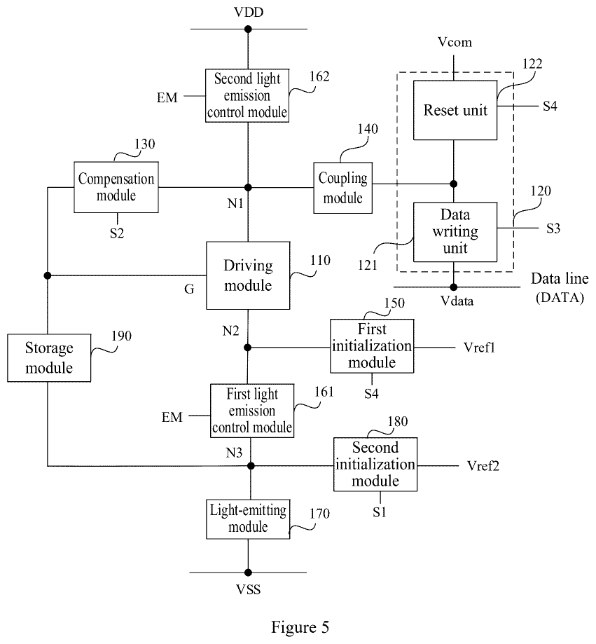

FIG. 5 is a schematic diagram of a structure of another pixel circuit according to an embodiment of the present application. Referring to FIG. 5, in one embodiment, the pixel circuit further includes a storage module 190. The storage module 190 is connected between the control terminal G of the driving module 110 and the first terminal of the light-emitting module 170, and is configured to store the voltage at the control terminal G of the driving module 110. When the first terminal of the light-emitting module 170 is initialized, the second initialization module 180 also initializes the storage module 190.

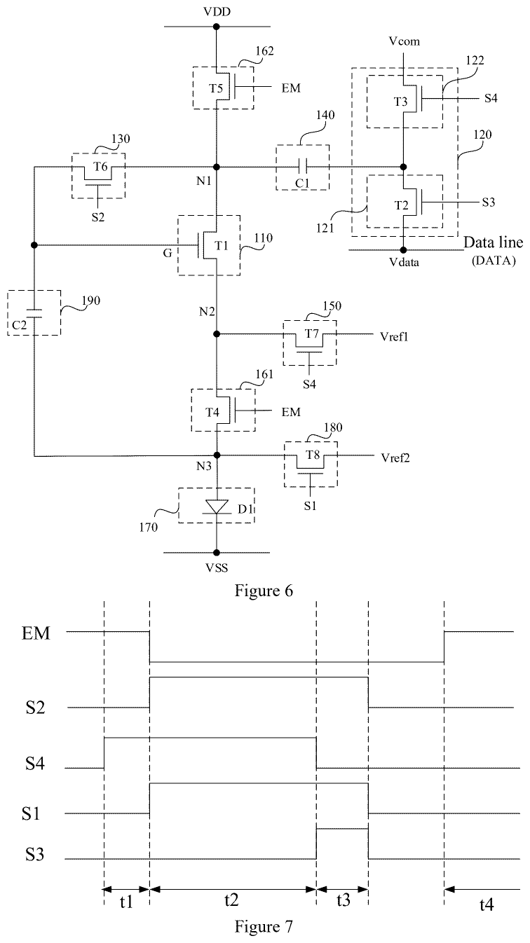

FIG. 6 is a schematic diagram of a structure of another pixel circuit according to an embodiment of the present application, which may be a schematic diagram of a structure of the pixel circuit shown in FIG. 5 that is refined into devices. Referring to FIG. 6, the driving module 110 includes a first transistor T1. The first transistor T1 is a drive transistor. A first electrode of the first transistor T1 is the first terminal N1 of the driving module 110, a second electrode of the first transistor T1 is the second terminal N2 of the driving module 110, and a gate of the first transistor T1 is the control terminal G of the driving module 110. The data writing unit 121 includes a second transistor T2. The coupling module 140 includes a first capacitor C1. A gate of the second transistor T2 is connected to the third scan line, a first electrode of the second transistor T2 is connected to the data line DATA, and a second electrode of the second transistor T2 is connected to a first electrode of the first capacitor C1. A second electrode of the first capacitor C1 is connected to the first electrode of the first transistor T1.

The reset unit 122 includes a third transistor T3. A gate of the third transistor T3 is connected to the fourth scan line, a first electrode of the third transistor T3 is connected to the fixed voltage Vcom, and a second electrode of the third transistor T3 is connected to the first electrode of the first capacitor C1.

The first light emission control module 161 includes a fourth transistor T4. The second light emission control module 162 includes a fifth transistor T5. The light-emitting module 170 includes a light-emitting diode D1. A gate of the fourth transistor T4 and a gate of the fifth transistor T5 are both connected to the light emission control signal line. A first electrode of the fifth transistor T5 is connected to the first power supply voltage terminal, and a second electrode of the fifth transistor T5 is connected to the first electrode of the first transistor T1. A first electrode of the fourth transistor T4 is connected to the second electrode of the first transistor T1, and a second electrode of the fourth transistor T4 is connected to a first electrode of the light-emitting diode D1. A second electrode of the light-emitting diode D1 is connected to the second power supply voltage terminal.

The compensation module 130 includes a sixth transistor T6. A gate of the sixth transistor T6 is connected to the second scan line, a first electrode of the sixth transistor T6 is connected to the first electrode of the first transistor T1, and a second electrode of the sixth transistor T6 is connected to the gate of the first transistor T1.

The first initialization module 150 includes a seventh transistor T7. The second initialization module 180 includes an eighth transistor T8. A gate of the seventh transistor T7 is connected to the fourth scan line, a first electrode of the seventh transistor T7 is connected to the first initialization signal line, and a second electrode of the seventh transistor T7 is connected to the second electrode of the first transistor T1. A gate of the eighth transistor T8 is connected to the first scan line, a first electrode of the eighth transistor T8 is connected to the second initialization signal line, and a second electrode of the eighth transistor T8 is connected to the first electrode of the light-emitting diode D1.

The storage module 190 includes a second capacitor C2. A first electrode of the second capacitor C2 is connected to the gate of the first transistor T1, and a second electrode of the second capacitor C2 is connected to the third node N3.

In the pixel circuit shown in FIG. 6, the transistors are all N-type transistors, which are cut off at a low level and conducted at a high level.

FIG. 7 is a schematic diagram of driving timing of a pixel circuit according to an embodiment of the present application. The driving timing is applicable to the pixel circuit shown in FIG. 6. Referring to FIG. 6 and FIG. 7, an operation process of the pixel circuit according to this embodiment includes an initialization phase t1, a compensation phase t2, a data writing phase t3, and a light emission phase t4.

In the initialization phase t1, the first scan signal S1 is at a low level, the second scan signal S2 is at a low level, the third scan signal S3 is at a low level, the fourth scan signal S4 is at a high level, and the light emission control signal EM is at a high level. Therefore, the third transistor T3, the fourth transistor T4, the fifth transistor T5, and the seventh transistor T7 are conducted. The fixed voltage Vcom is transmitted to the first electrode of the first capacitor C1 via the third transistor T3, the first power supply voltage VDD is transmitted to the first electrode of the first transistor T1 via the fifth transistor T5, and the first initialization voltage Vref1 is transmitted to the second electrode of the first transistor T1 via the seventh transistor T7. Therefore, a voltage at the first electrode of the first capacitor C1 is Vcom, a voltage at the second electrode of the first capacitor C1 is VDD, and a voltage at the first electrode of the first transistor T1 is VDD. A reset current of the pixel circuit is determined by the first transistor T1 and the voltage difference between the first power supply voltage VDD and the first initialization voltage Vref1. The voltage difference between the first power supply voltage VDD and the first initialization voltage Vref1 can be reduced by increasing the first initialization voltage Vref1, thereby reducing the reset current. This helps reduce power consumption, and also helps reduce display crosstalk, brightness nonuniformity, and the like caused by the IR-Drop in the first initialization voltage Vref1.

In the compensation phase t2, the first scan signal S1 is at a high level, the second scan signal S2 is at a high level, the third scan signal S3 is at a low level, the fourth scan signal S4 is at a high level, and the light emission control signal EM is at a low level. Therefore, the third transistor T3, the sixth transistor T6, the seventh transistor T7, and the eighth transistor T8 are conducted. The gate and the first electrode of the first transistor T1 are short-circuited to form a diode structure. A discharge path is formed between the first terminal N1 of the driving module 110 and the seventh transistor T7. The first transistor T1 is cut off when the voltage at the first terminal N1 of the driving module 110 drops to Vref1+Vth1, where Vth1 is a threshold voltage of the first transistor T1. In this case, a gate voltage of the first transistor T1 is also Vref1+Vth1, and the first initialization voltage Vref1 can be transmitted to the gate of the first transistor T1 while the threshold compensation is achieved, to initialize the gate of the first transistor T1. Moreover, in the compensation phase t2, a voltage at the first electrode of the light-emitting diode D1 is maintained at the second initialization voltage Vref2, to prevent the light-emitting diode D1 from emitting light. The second capacitor C2 stores the gate voltage of the first transistor T1.

In this embodiment, the first initialization voltage Vref1 is greater than the second initialization voltage Vref2. When the threshold voltage Vth1 of the first transistor T1 is compensated, because the voltage difference between the first power supply voltage and the first initialization voltage Vref1 is small, the reset current can be controlled within a small range, to avoid an excessively large reset current, thereby helping reduce power consumption.

In the data writing phase t3, the first scan signal S1 is at a high level, the second scan signal S2 is at a high level, the third scan signal S3 is at a high level, the fourth scan signal S4 is at a low level, and the light emission control signal EM is at a low level. Therefore, the second transistor T2, the sixth transistor T6, and the eighth transistor T8 are conducted. The data voltage Vdata on the data line DATA is transmitted to the first electrode of the first capacitor C1 via the second transistor T2. The voltage at the first electrode of the first capacitor C1 jumps from the fixed voltage Vcom to the data voltage Vdata. A variation of the voltage at the first electrode of the first capacitor C1 is Vdata-Vcom. Because the sixth transistor T6 is in a conducted state, under a coupling action of the first capacitor C1, the gate voltage of the first transistor T1 is Vref1+Vth1+c1(Vdata−Vcom)/(c1+c2+cgs) and is stored on the second capacitor C2. A voltage at the second electrode of the second capacitor C2 is maintained at the second initialization voltage Vref2 under a holding action of the seventh transistor T7. A voltage difference between two terminals of the second capacitor C2 is Vref1−Vref2+Vth 1+c1(Vdata−Vcom)/(c1+c2+cgs), where c1 is a capacitance value of the first capacitor C1, c2 is a capacitance value of the second capacitor C2, and cgs is a capacitance value of parasitic capacitance between the gate and the second electrode of the first transistor T1.

When the second scan signal S2 jumps from an on level to an off level, a coupling action is produced on the gate of the first transistor T1, pulling down the gate voltage of the first transistor T1. This facilitates maintaining a low potential at the gate of the first transistor T1, avoids a loss of threshold compensation, and eliminates a problem of a loss of a gate voltage of the drive transistor caused by potential coupling.

In the light emission phase t4, the first scan signal S1 is at a low level, the second scan signal S2 is at a low level, the third scan signal S3 is at a low level, the fourth scan signal S4 is at a low level, and the light emission control signal EM is at a high level. Therefore, the fourth transistor T4 and the fifth transistor T5 are conducted. The first power supply voltage VDD is transmitted to the first electrode of the first transistor T1 via the fifth transistor T5. Because the sixth transistor T6 remains in a cut-off state, the gate voltage of the first transistor T1 does not change, and the first transistor T1 generates a drive current I based on the voltage at the gate and the voltage at the first electrode of the first transistor T1, to drive the light-emitting diode D1 to emit light. The drive current I may be expressed as:

$$I = \frac{1}{2} μ {C}_{ox} \frac{W}{L} {( V gs - V th 1 )}^{2} = \frac{1}{2} μ {C}_{ox} {\frac{W}{L} [ V ref 1 - V ref 2 + c 1 ( V data - V com ) / ( c 1 + c 2 + cgs ) ]}^{2} ,$$

where μ is electron mobility of the first transistor T1, Cₒₓ is channel capacitance per unit area of the first transistor T1, and W/L is an aspect ratio of the first transistor T1.

It can be learned from the formula of the drive current I, the drive current I is independent of the first power supply voltage VDD, the second power supply voltage VSS, and the threshold voltage Vth1 of the first transistor T1. Therefore, the pixel circuit according to this embodiment can compensate for the threshold voltage of the first transistor T1, and solve the problem of display nonuniformity caused by a voltage drop (IR-Drop) of the first power supply voltage VDD and the second power supply voltage VSS, and the like, thereby helping improve display quality.

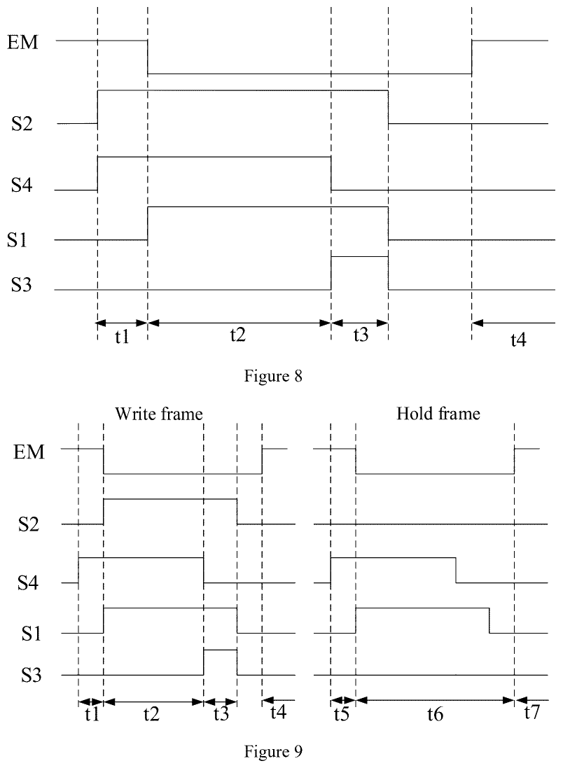

FIG. 8 is a schematic diagram of driving timing of another pixel circuit according to an embodiment of the present application. A difference between the driving timing shown in FIG. 8 and the driving timing shown in FIG. 7 is that, in the initialization phase t1, the second scan signal S2 is at a high level, the sixth transistor T6 is conducted, and the first power supply voltage VDD is transmitted to the first electrode of the first transistor T1 via the fifth transistor T5 and to the gate of the first transistor T1 via the sixth transistor T6. Operation processes of other phases are the same as the operation process in the driving timing shown in FIG. 7, and details are not described again.

FIG. 9 is a schematic diagram of driving timing of another pixel circuit according to an embodiment of the present application. The driving timing is applicable to driving of the pixel circuit shown in FIG. 6 at a low refresh rate. A display cycle includes a write frame and a hold frame. At the low refresh rate, one data frame is used as the write frame, another data frame is used as the hold frame, data is written merely in the write frame, and no data is written in the hold frame. Referring to FIG. 9 and FIG. 6, in the write frame, a driving method for the pixel circuit is the same as a driving method in the driving timing shown in FIG. 7.

In the same display cycle, an operation process of a phase t5 in a hold frame (an initialization phase in the hold frame) is the same as an operation process of an initialization phase t1 in a write frame.

In a phase t6, the eighth transistor T8 is conducted in response to the first scan signal S1, to initialize the first electrode of the light-emitting diode D1, thereby preventing the light-emitting diode D1 from flickering at the low refresh rate.

An operation process of a phase t7 is the same as that of the light emission phase t4.

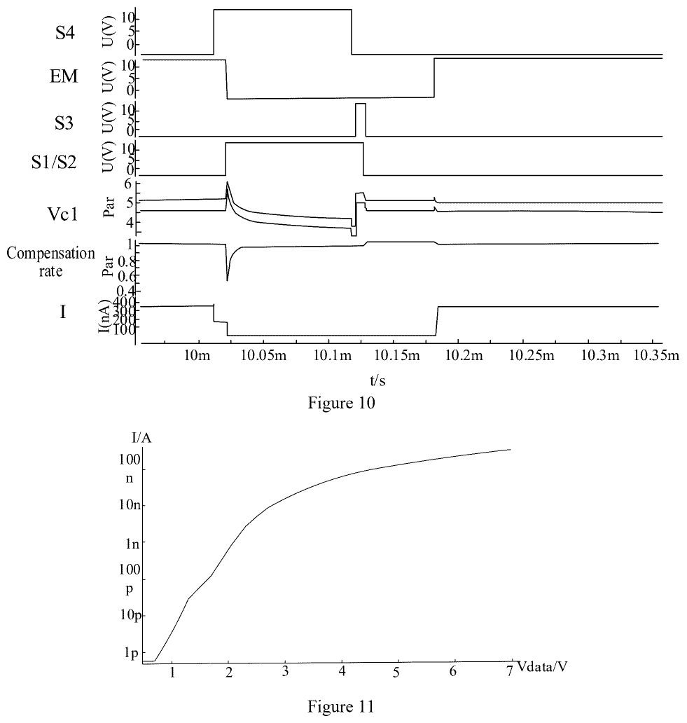

FIG. 10 is a schematic diagram of a simulation of a compensation effect according to an embodiment of the present application. The compensation effect may be a compensation effect of the pixel circuit shown in FIG. 6 in the driving timing shown in FIG. 7. Referring to FIG. 10, when the threshold voltage Vth1 of the first transistor T1 drifts by 0.5 V, a fluctuation of display brightness at a high gray scale is 0.69%, and a compensation rate is 1.024, which is close to 1. Therefore, the compensation effect is greatly improved.

FIG. 11 is a schematic diagram of gray scale expansion according to an embodiment of the present application. Referring to FIG. 11, the pixel circuit according to this embodiment can cover current drive requirements corresponding to a black state and 0-255 gray scales when the data voltage Vdata is within a range of 1-7 V.

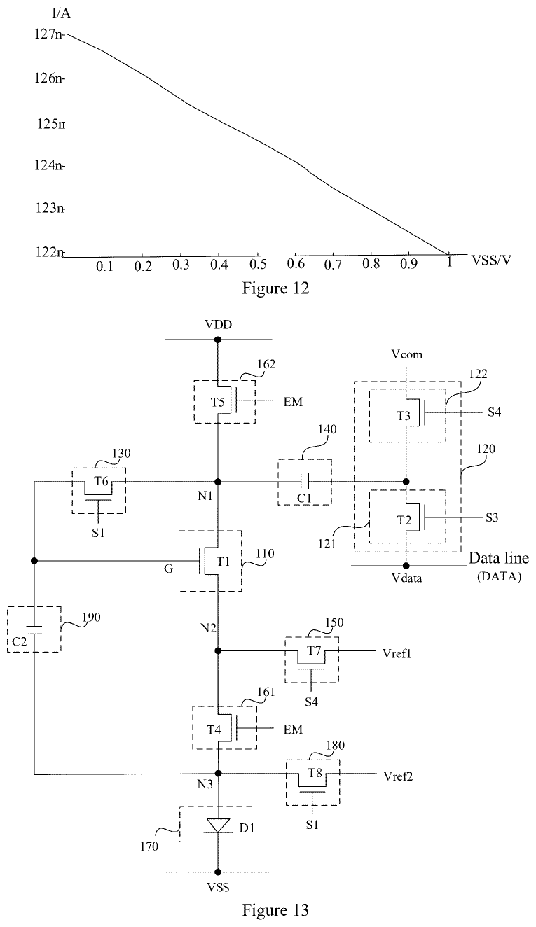

FIG. 12 is a schematic diagram of a simulation of IR-Drop in a second power supply voltage according to an embodiment of the present application. Referring to FIG. 12, when the second power supply voltage VSS is reduced by 1 V, display brightness decreases to 96%. A compensation effect on the IR-Drop in the second power supply voltage VSS is improved within an acceptable range.

In conclusion, the pixel circuit according to this embodiment can enhance a compensation action on the threshold voltage Vth1 of the first transistor T1 (the drive transistor), helping reduce image retention, and has a compensation action on the IR-Drop in the first power supply voltage VDD and the second power supply voltage VSS, improving display uniformity. This embodiment is applied to a large range of refresh rates, greatly improves black-state performance, and has high contrast.

FIG. 13 is a schematic diagram of a structure of another pixel circuit according to an embodiment of the present application. Referring to FIG. 13, based on the embodiments described above, in one embodiment, the first scan line may be reused as the second scan line, the gate of the sixth transistor T6 and the gate of the eighth transistor T8 are both connected to the first scan signal S1, and the gate of the sixth transistor T6 and the eighth transistor T8 operate in the same state. Compared with the pixel circuit shown in FIG. 6, the pixel circuit shown in FIG. 13 can reduce a requirement for one set of gate drive circuits, and the first scan signal S1 and the fourth scan signal S4 may be generated by the same set of gate drive circuits. Therefore, the pixel circuit shown in FIG. 13 requires only three sets of gate drive circuits for driving.

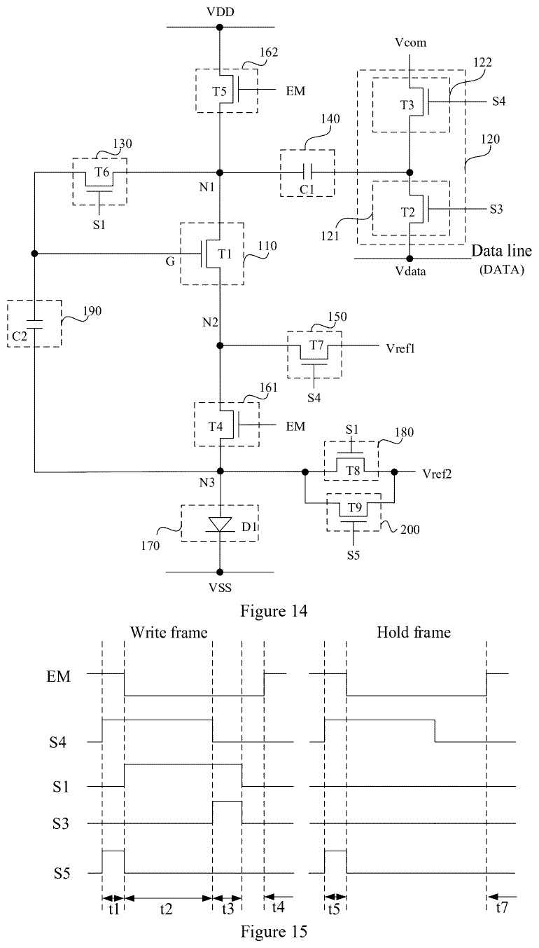

In one embodiment, in the pixel circuit shown in FIG. 13, when a display panel displays at a low refresh rate, because data writing and threshold compensation are not performed in the hold frame, the eighth transistor T8 and the sixth transistor T6 are in the cut-off state in the hold frame, the first electrode of the light-emitting diode D1 cannot be reset, and flicker is likely to occur in the light emission phase. To solve the above problem, the first electrode of the light-emitting diode D1 may be reset separately by another module. FIG. 14 is a schematic diagram of a structure of another pixel circuit according to an embodiment of the present application. Referring to FIG. 14, based on the above embodiments, the pixel circuit further includes a third initialization module 200. A control terminal of the third initialization module 200 is connected to a fifth scan line, a first terminal of the third initialization module 200 is connected to the second initialization signal line, and a second terminal of the third initialization module 200 is connected to the first terminal of the light-emitting module 170. The third initialization module 200 is configured to transmit the second initialization voltage Vref2 to the first terminal of the light-emitting module 170 in an initialization phase in a write frame of a display cycle, and transmit the second initialization voltage Vref2 to the first terminal of the light-emitting module 170 in an initialization phase in a hold frame of the same display cycle.

The third initialization module 200 includes a ninth transistor T9. A gate of the ninth transistor T9 is connected to the fifth scan line, a first electrode of the ninth transistor T9 is connected to the second initialization signal line, and a second electrode of the ninth transistor T9 is connected to the first electrode of the light-emitting diode D1.

FIG. 15 is a schematic diagram of driving timing of another pixel circuit according to an embodiment of the present application. The driving timing is applicable to driving of the pixel circuit shown in FIG. 14 at a low refresh rate.

The write frame includes at least an initialization phase t1, a compensation phase t2, a data writing phase t3, and a light emission phase t4. In the write frame, a driving method for the pixel circuit is similar to a driving method in the driving timing shown in FIG. 7, and reference may be made to the related description of the driving timing shown in FIG. 7. Details are not described herein again.

In the hold frame, in the phase t5 (the initialization phase in the hold frame), a fifth scan signal S5 is at a high level, the fourth scan signal S4 is at a high level, and the light emission control signal EM is at a high level. The third transistor T3, the fourth transistor T4, the fifth transistor T5, and the ninth transistor T9 are conducted. The second initialization voltage Vref2 is transmitted to the first electrode of the light-emitting diode D1 via the ninth transistor T9, to initialize the first electrode of the light-emitting diode D1.

The operation process of the phase t7 (a light emission phase in the hold frame) is the same as that of the light emission phase t4 in the write frame, and details are not described again.

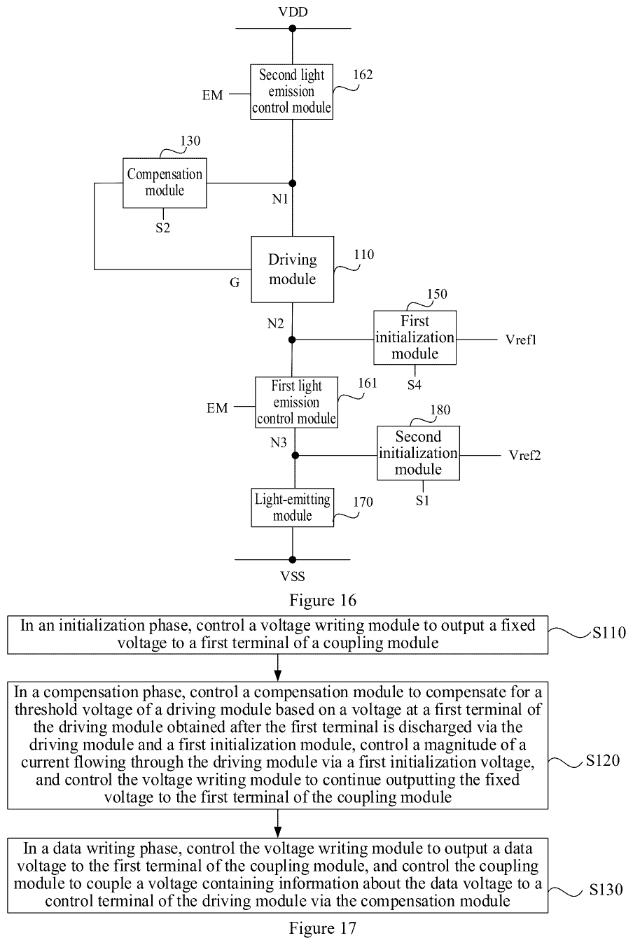

FIG. 16 is a schematic diagram of a structure of another pixel circuit according to an embodiment of the present application. Referring to FIG. 16, the pixel circuit according to this embodiment includes a driving module 110, a compensation module 130, a first initialization module 150, a second initialization module 180, a first light emission control module 161, and a light-emitting module 170.

The driving module 110 and the light-emitting module 170 are connected between a first power supply voltage terminal and a second power supply voltage terminal. The driving module 110 is configured to drive the light-emitting module 170 to emit light in a light emission phase.

The first light emission control module 161 is connected between a second terminal of the driving module 110 and a first terminal of the light-emitting module 170. The first initialization module 150 is connected to the second terminal N2 of the driving module 110. The first initialization module 150 is configured to control a magnitude of a current flowing through the driving module 110 based on a first initialization voltage Vref1 connected to the first initialization module 150.

The second initialization module 180 is connected to the first terminal (a third node N3) of the light-emitting module 170. The second initialization module 180 is configured to transmit a second initialization voltage Vref2 to the first terminal of the light-emitting module 170 at least in a compensation phase, where the first initialization voltage Vref1 is greater than the second initialization voltage Vref2.

The compensation module 130 is connected between a control terminal G and a first terminal N1 of the driving module 110. The compensation module 130 is configured to compensate for a threshold voltage of the driving module 110 in the compensation phase based on a voltage at the first terminal N1 of the driving module 110 obtained after the first terminal N1 is discharged via the driving module 110 and the first initialization module 150.

For example, the first power supply voltage terminal is configured to be connected to a first power supply voltage VDD, and the second power supply voltage terminal is configured to be connected to a second power supply voltage VSS. An operation process of the pixel circuit includes at least an initialization phase and a compensation phase.

In the compensation phase, the first initialization module 150 and the compensation module 130 are conducted, the control terminal G and the first terminal N1 of the driving module 110 are connected, and the first power supply voltage VDD is transmitted to the first terminal N1 of the driving module 110, and transmitted to the control terminal G of the driving module 110 via the compensation module 130. The voltage at the first terminal N1 of the driving module 110 is discharged via the driving module 110 and the first initialization module 150. The driving module 110 is cut off when a voltage difference between the control terminal G and the second terminal N2 of the driving module 110 is equal to a threshold voltage of the driving module 110, and the voltage at the first terminal N1 and the control terminal G of the driving module 110 is a difference between the first initialization voltage Vref1 and the threshold voltage of the driving module 110, implementing compensation for the threshold voltage of the driving module 110. At the same time, the second initialization module 180 is conducted, and transmits the second initialization voltage Vref2 to the first terminal of the light-emitting module 170, to initialize the first terminal of the light-emitting module 170.

In this embodiment, the first initialization voltage Vref1 is greater than the second initialization voltage Vref2. The first terminal of the light-emitting module 170 can be reset to a lower voltage via a low second initialization voltage Vref2, to ensure that the first terminal of the light-emitting module 170 is fully initialized, where the second initialization voltage Vref2 is lower than a turn-on voltage of the light-emitting module 170, for example, the second initialization voltage Vref2 may be a negative voltage. In addition, setting the higher first initialization voltage Vref1 can reduce a voltage difference between the first power supply voltage VDD and the first initialization voltage Vref1, and can therefore control a reset current within a small range, to avoid an excessively large reset current, thereby helping reduce power consumption.

In this embodiment, the first initialization voltage Vref1 may be provided by a first initialization signal line, and the second initialization voltage Vref2 may be provided by a second initialization signal line. That is, the first initialization module 150 is connected between the first initialization signal line and the second terminal N2 of the driving module 110, and the second initialization module 180 is connected between the second initialization signal line and the first terminal of the light-emitting module 170.

In one embodiment, based on the pixel circuit shown in FIG. 16, the pixel circuit further includes a voltage writing module 120 and a coupling module 140 (as shown in FIG. 2). The voltage writing module 120 is configured to output a fixed voltage Vcom to a first terminal of the coupling module 140 at least in the compensation phase and output a data voltage Vdata to the first terminal of the coupling module 140 in a data writing phase. The coupling module 140 is configured to couple a voltage containing information about the data voltage Vdata to the control terminal G of the driving module 110 via the compensation module 130 in the data writing phase. The data writing phase is later than the compensation phase. For the operation process of the pixel circuit, reference may be made to the related descriptions of FIG. 2, FIG. 3, and FIG. 4 in the above embodiments. Details are not described again.

One embodiment of the present application further provides a driving method for a pixel circuit. FIG. 17 is a flowchart of a driving method for a pixel circuit according to an embodiment of the present application. Referring to FIG. 17, the driving method for a pixel circuit includes the following steps.
S110: In an initialization phase, control a voltage writing module to output a fixed voltage to a first terminal of a coupling module.
S120: In a compensation phase, control a compensation module to compensate for a threshold voltage of a driving module based on a voltage at a first terminal of the driving module obtained after the first terminal is discharged via the driving module and a first initialization module, control a magnitude of a current flowing through the driving module via a first initialization voltage, and control the voltage writing module to continue outputting the fixed voltage to the first terminal of the coupling module.
S130: In a data writing phase, control the voltage writing module to output a data voltage to the first terminal of the coupling module, and control the coupling module to couple a voltage containing information about the data voltage to a control terminal of the driving module via the compensation module.

According to the embodiments of the present application, the compensation module is provided between the control terminal and the first terminal of the driving module. In the compensation phase, the compensation module is controlled to be turned on, a potential at the first terminal of the driving module is transmitted to the control terminal of the driving module, and the driving module is turned on, and the compensation module compensates for the threshold voltage of the driving module based on the voltage at the first terminal of the driving module obtained after the first terminal is discharged via the driving module and the first initialization module. A magnitude of the first initialization voltage is adjusted, and the current flowing through the driving module can be adjusted. This effectively avoids a problem of increased power consumption caused by an excessively large current, and can reduce a problem of display nonuniformity caused by IR-Drop in the first initialization voltage, thereby helping improve a display effect. Furthermore, in this embodiment, threshold compensation and data writing for the driving module are not performed simultaneously, and the threshold compensation is performed before the data voltage is written to the control terminal of the driving module. Therefore, a threshold compensation phase and the data writing phase do not affect each other, time for the threshold compensation is not affected by line time, and the threshold voltage of the driving module can be fully compensated even at a high refresh rate. This can reduce a difference in characteristics of driving modules corresponding to different pixels, and then helps reduce a difference in display brightness, thereby improving uniformity of a displayed image.

In one embodiment, referring to FIG. 5, the pixel circuit further includes a light-emitting module 170, a first light emission control module 161, and a second light emission control module 162. The second light emission control module 162 is connected between a first power supply voltage terminal and the first terminal N1 of the driving module 110. The first light emission control module 161 is connected between a second terminal N2 of the driving module 110 and a first terminal of the light-emitting module 170. A second terminal of the light-emitting module 170 is connected to a second power supply voltage terminal. A control terminal of the first light emission control module 161 and a control terminal of the second light emission control module 162 are both connected to a light emission control signal line. A voltage writing module 120 includes a data writing unit 121 and a reset unit 122. A first terminal of the reset unit 122 is connected to the fixed voltage Vcom, and a second terminal of the reset unit 122 is connected to the first terminal of the coupling module 140. The first terminal of the coupling module 140 is further connected to a second terminal of the data writing unit 121. A first terminal of the data writing unit 121 is connected to a data line DATA. A control terminal of the data writing unit 121 is connected to a third scan line. A control terminal of the reset unit 122 is connected to a fourth scan line. The pixel circuit further includes a second initialization module 180. The second initialization module 180 is connected between a second initialization signal line and the first terminal of the light-emitting module 170.

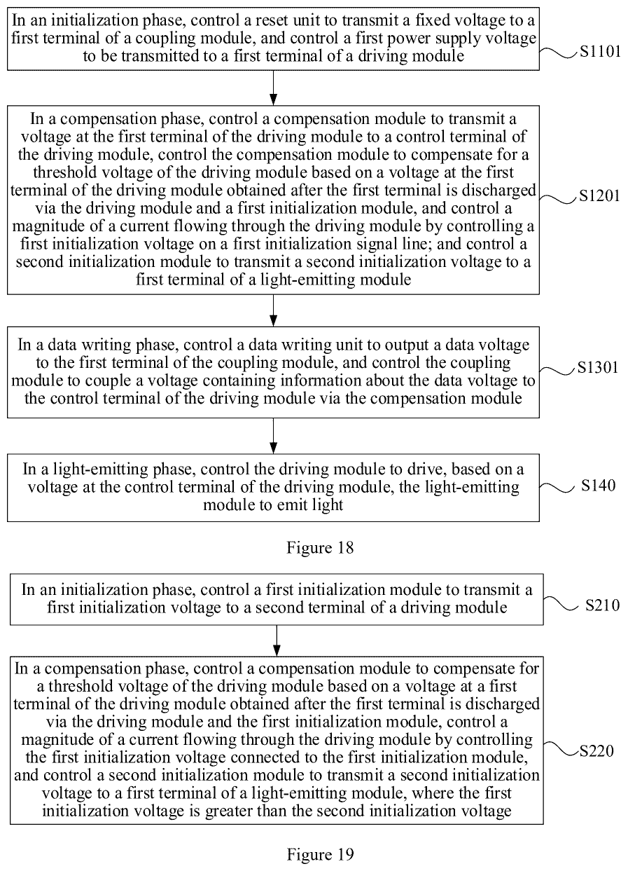

FIG. 18 is a flowchart of another driving method for a pixel circuit according to an embodiment of the present application. Referring to FIG. 18, the driving method for a pixel circuit includes the following steps.
S1101: In an initialization phase, control a reset unit to transmit a fixed voltage to a first terminal of a coupling module, and control a first power supply voltage to be transmitted to a first terminal of a driving module.
S1201: In a compensation phase, control a compensation module to transmit a voltage at the first terminal of the driving module to a control terminal of the driving module, control the compensation module to compensate for a threshold voltage of the driving module based on a voltage at the first terminal of the driving module obtained after the first terminal is discharged via the driving module and a first initialization module, and control a magnitude of a current flowing through the driving module by controlling a first initialization voltage on a first initialization signal line; and control a second initialization module to transmit a second initialization voltage to a first terminal of a light-emitting module.
S1301: In a data writing phase, control a data writing unit to output a data voltage to the first terminal of the coupling module, and control the coupling module to couple a voltage containing information about the data voltage to the control terminal of the driving module via the compensation module.
S140: In a light emission phase, control the driving module to drive, based on a voltage at the control terminal of the driving module, the light-emitting module to emit light.

For an operation process of the driving method for a pixel circuit shown in FIG. 18, reference may be made to the related description of the pixel circuit shown in FIG. 5. Details are not described again. The driving method for a pixel circuit shown in FIG. 18 has the effects described in any above embodiment.

FIG. 19 is another driving method for a pixel circuit according to an embodiment of the present application. The driving method is applicable to driving of the pixel circuit shown in FIG. 12. Referring to FIG. 16 and FIG. 19, the driving method for a pixel circuit includes the following steps.
S210: In an initialization phase, control a first initialization module to transmit a first initialization voltage to a second terminal of a driving module.
S220: In a compensation phase, control a compensation module to compensate for a threshold voltage of the driving module based on a voltage at a first terminal of the driving module obtained after the first terminal is discharged via the driving module and the first initialization module, control a magnitude of a current flowing through the driving module by controlling the first initialization voltage connected to the first initialization module, and control a second initialization module to transmit a second initialization voltage to a first terminal of a light-emitting module, where the first initialization voltage is greater than the second initialization voltage.

According to this embodiment, compensation for the threshold voltage of the driving module and initialization of the light-emitting module are respectively implemented through different paths. In this way, the first terminal of the light-emitting module 170 can be reset to a lower voltage via a low second initialization voltage Vref2, to ensure that the first terminal of the light-emitting module 170 is fully initialized. In addition, setting the higher first initialization voltage Vref1 can reduce a voltage difference between a first power supply voltage VDD and the first initialization voltage Vref1, and can therefore control a reset current within a small range, to avoid an excessively large reset current, thereby helping reduce power consumption.

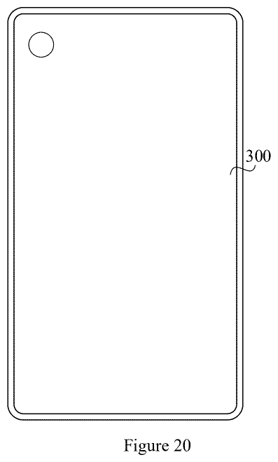

An embodiment of the present application further provides a display panel, including the pixel circuit provided in the above embodiments. Therefore, the display panel also has the beneficial effects described in any above embodiment. FIG. 20 is a schematic diagram of a structure of a display panel according to an embodiment of the present application. In this embodiment, the display panel 300 may be used in a mobile phone or to any electronic product with a display function, including the following categories: a TV set, a notebook computer, a desktop monitor, a tablet computer, a digital camera, a smart bracelet, smart glasses, a vehicle-mounted display, medical equipment, industrial control equipment, a touch interactive terminal, and the like. This is not specifically limited in the embodiments of the present application.

1. A pixel circuit, comprising:
a driving module, a voltage writing module, a compensation module, a coupling module, and a first initialization module, wherein
the first initialization module is connected to a second terminal of the driving module, and the first initialization module is configured to control a magnitude of a current flowing through the driving module;
the compensation module is connected between a control terminal and a first terminal of the driving module, and the compensation module is configured to compensate for a threshold voltage of the driving module in a compensation phase based on a voltage at the first terminal of the driving module obtained after the first terminal is discharged via the driving module and the first initialization module; and
a first terminal of the coupling module is connected to the voltage writing module, a second terminal of the coupling module is connected to the first terminal of the driving module, the voltage writing module is configured to output a fixed voltage to the first terminal of the coupling module at least in the compensation phase and output a data voltage to the first terminal of the coupling module in a data writing phase, and the coupling module is configured to couple a voltage containing information about the data voltage to the control terminal of the driving module via the compensation module in the data writing phase, wherein the data writing phase is later than the compensation phase.

2. The pixel circuit according to claim 1, further comprising a light-emitting module, wherein the driving module and the light-emitting module are connected between a first power supply voltage terminal and a second power supply voltage terminal, and the driving module is configured to drive the light-emitting module to emit light in a light emission phase.

3. The pixel circuit according to claim 2, further comprising a first light emission control module and a second light emission control module, wherein the second light emission control module is connected between the first power supply voltage terminal and the first terminal of the driving module, the first light emission control module is connected between the second terminal of the driving module and a first terminal of the light-emitting module, and a second terminal of the light-emitting module is connected to the second power supply voltage terminal; and a control terminal of the first light emission control module and a control terminal of the second light emission control module are both connected to a light emission control signal line.

4. The pixel circuit according to claim 2, further comprising a second initialization module, wherein the second initialization module is connected between a second initialization signal line and the first terminal of the light-emitting module, a control terminal of the second initialization module is connected to a first scan line, and the second initialization module is configured to transmit a second initialization voltage on the second initialization signal line to the first terminal of the light-emitting module at least in the compensation phase;
the first initialization module is connected between a first initialization signal line and the second terminal of the driving module;
a first initialization voltage on the first initialization signal line is greater than the second initialization voltage;
a control terminal of the compensation module is connected to a second scan line; and
a start moment of the data writing phase is later than an end moment of the compensation phase.

5. The pixel circuit according to claim 1, wherein the voltage writing module comprises a data writing unit, a control terminal of the data writing unit is connected to a third scan line, a first terminal of the data writing unit is connected to a data line, and a second terminal of the data writing unit is connected to the first terminal of the coupling module;
the data line is configured to transmit the fixed voltage in an initialization phase to initialize a potential at the first terminal of the coupling module, continue transmitting the fixed voltage in the compensation phase, and transmit the data voltage in the data writing phase; and
the compensation module is further configured to transmit a potential at the first terminal of the driving module to the control terminal of the driving module in the compensation phase.

6. The pixel circuit according to claim 1, wherein the voltage writing module comprises a data writing unit and a reset unit, a first terminal of the reset unit is connected to the fixed voltage, a second terminal of the reset unit is connected to the first terminal of the coupling module, the first terminal of the coupling module is further connected to a second terminal of the data writing unit, a first terminal of the data writing unit is connected to a data line, a control terminal of the data writing unit is connected to a third scan line, a control terminal of the reset unit is connected to a fourth scan line, the reset unit is configured to transmit the fixed voltage to the first terminal of the coupling module in an initialization phase and continue transmitting the fixed voltage to the first terminal of the coupling module in the compensation phase, and the data writing unit is configured to transmit the data voltage to the first terminal of the coupling module in the data writing phase.

7. The pixel circuit according to claim 6, wherein the first initialization module is connected between a first initialization signal line and the second terminal of the driving module, a first initialization voltage on the first initialization signal line is reused as the fixed voltage, and a control terminal of the first initialization module is connected to the fourth scan line.

8. The pixel circuit according to claim 6, further comprising a storage module, wherein the storage module is connected between the control terminal of the driving module and a first terminal of a light-emitting module.

9. The pixel circuit according to claim 4, wherein the first scan line is reused as the second scan line; and
the pixel circuit further comprises a third initialization module, a control terminal of the third initialization module is connected to a fifth scan line, a first terminal of the third initialization module is connected to the second initialization signal line, a second terminal of the third initialization module is connected to the first terminal of the light-emitting module, and the third initialization module is configured to transmit the second initialization voltage to the first terminal of the light-emitting module in an initialization phase in a write frame of a display cycle, and transmit the second initialization voltage to the first terminal of the light-emitting module in an initialization phase in a hold frame of the same display cycle.

10. A pixel circuit, comprising:
a driving module, a compensation module, a first initialization module, a second initialization module, a first light emission control module, and a light-emitting module, wherein
the driving module and the light-emitting module are connected between a first power supply voltage terminal and a second power supply voltage terminal, and the driving module is configured to drive the light-emitting module to emit light in a light emission phase;
the first light emission control module is connected between a second terminal of the driving module and a first terminal of the light-emitting module, the first initialization module is connected to the second terminal of the driving module, and the first initialization module is configured to control a magnitude of a current flowing through the driving module based on a first initialization voltage connected to the first initialization module;
the second initialization module is connected to the first terminal of the light-emitting module, and the second initialization module is configured to transmit a second initialization voltage to the first terminal of the light-emitting module at least in a compensation phase, wherein the first initialization voltage is greater than the second initialization voltage; and
the compensation module is connected between a control terminal and a first terminal of the driving module, and the compensation module is configured to compensate for a threshold voltage of the driving module in the compensation phase based on a voltage at the first terminal of the driving module obtained after the first terminal is discharged via the driving module and the first initialization module.

11. The pixel circuit according to claim 10, further comprising a voltage writing module and a coupling module, wherein the voltage writing module is configured to output a fixed voltage to a first terminal of the coupling module at least in the compensation phase and output a data voltage to the first terminal of the coupling module in a data writing phase, and the coupling module is configured to couple a voltage containing information about the data voltage to the control terminal of the driving module via the compensation module in the data writing phase, wherein the data writing phase is later than the compensation phase.

12. The pixel circuit according to claim 11, wherein a start moment of the data writing phase is later than an end moment of the compensation phase;
the voltage writing module comprises a data writing unit, a control terminal of the data writing unit is connected to a third scan line, a first terminal of the data writing unit is connected to a data line, and a second terminal of the data writing unit is connected to the first terminal of the coupling module; the data line is configured to transmit the fixed voltage in an initialization phase to initialize a potential at the first terminal of the coupling module, continue transmitting the fixed voltage in the compensation phase, and transmit the data voltage in the data writing phase;
or, the voltage writing module comprises a data writing unit and a reset unit, a first terminal of the reset unit is connected to the fixed voltage, a second terminal of the reset unit is connected to the first terminal of the coupling module, a second terminal of the coupling module is connected to the first terminal of the driving module, the first terminal of the coupling module is further connected to a second terminal of the data writing unit, a first terminal of the data writing unit is connected to a data line, a control terminal of the data writing unit is connected to a third scan line, a control terminal of the reset unit is connected to a fourth scan line, the reset unit is configured to transmit the fixed voltage to the first terminal of the coupling module in an initialization phase and continue transmitting the fixed voltage to the first terminal of the coupling module in the compensation phase, and the data writing unit is configured to transmit the data voltage to the first terminal of the coupling module in the data writing phase.

13. The pixel circuit according to claim 11, further comprising a second light emission control module, wherein the second light emission control module is connected between the first power supply voltage terminal and the first terminal of the driving module, and a control terminal of the first light emission control module and a control terminal of the second light emission control module are both connected to a light emission control signal line.

14. The pixel circuit according to claim 11, further comprising a storage module, wherein the storage module is connected between the control terminal of the driving module and the first terminal of the light-emitting module.

15. A driving method for a pixel circuit, wherein the pixel circuit comprises a driving module, a voltage writing module, a compensation module, a coupling module, and a first initialization module; and
the driving method for a pixel circuit comprises:
in an initialization phase, controlling the voltage writing module to output a fixed voltage to a first terminal of the coupling module;
in a compensation phase, controlling the compensation module to compensate for a threshold voltage of the driving module based on a voltage at a first terminal of the driving module obtained after the first terminal is discharged via the driving module and the first initialization module, controlling a magnitude of a current flowing through the driving module via a first initialization voltage, and controlling the voltage writing module to continue outputting the fixed voltage to the first terminal of the coupling module; and
in a data writing phase, controlling the voltage writing module to output a data voltage to the first terminal of the coupling module, and controlling the coupling module to couple a voltage containing information about the data voltage to a control terminal of the driving module via the compensation module.

16. The driving method for a pixel circuit according to claim 15, wherein the pixel circuit further comprises a second initialization module, and the method further comprises: at least in the compensation phase, controlling the second initialization module to transmit a second initialization voltage to a first terminal of a light-emitting module.

17. The driving method for a pixel circuit according to claim 16, wherein the first initialization voltage is greater than the second initialization voltage.

18. The driving method for a pixel circuit according to claim 16, wherein the voltage writing module comprises a data writing unit and a reset unit; the controlling the voltage writing module to output a fixed voltage to a first terminal of the coupling module comprises:
controlling the reset unit to transmit the fixed voltage to the first terminal of the coupling module; and
the controlling the voltage writing module to output a data voltage to the first terminal of the coupling module comprises:
controlling the data writing unit to output the data voltage to the first terminal of the coupling module.

19. The driving method for a pixel circuit according to claim 16, wherein in the initialization phase, the driving method for a pixel circuit further comprises: controlling a first power supply voltage to be transmitted to the first terminal of the driving module.

20. A driving method for a pixel circuit, wherein the pixel circuit comprises a driving module, a compensation module, a first initialization module, a second initialization module, and a light-emitting module; and
the driving method for a pixel circuit comprises:
in a compensation phase, controlling the compensation module to compensate for a threshold voltage of the driving module based on a voltage at a first terminal of the driving module obtained after the first terminal is discharged via the driving module and the first initialization module, controlling a magnitude of a current flowing through the driving module via a first initialization voltage connected to the first initialization module, and controlling the second initialization module to transmit a second initialization voltage to a first terminal of the light-emitting module, wherein the first initialization voltage is greater than the second initialization voltage.
